(19) United States
(12) Patent Application Publication
(10) Pub. No.: US 2021/0316385 A1
(43) Pub. Date: Oct. 14, 2021

(54) Gas Shielded Triple-Wire Indirect Arc Welding Method, Device and Application Thereof

(71) Applicant: DALIAN UNIVERSITY OF TECHNOLOGY, Dalian, Liaoning (CN)

(72) Inventors: Liming LIU, Dalian, Liaoning (CN); Gang SONG, Dalian, Liaoning (CN); Zhaodong ZHANG, Dalian, Liaoning (CN); Chenghui HU, Dalian, Liaoning (CN)

(21) Appl. No.: 17/272,927

(22) PCT Filed: Nov. 13, 2018
(86) PCT No.: PCT/CN2018/115249

§ 371 Date: Mar. 2, 2021

(30) Foreign Application Priority Data
Sep. 14, 2018 (CN) 201811075326.5

(51) Int. Cl. B23K 9/16; B23K 9/04

(52) U.S. Cl. CPC B23K 9/164; B23K 9/04

(57) ABSTRACT

A gas shielded triple-wire indirect arc welding device has three welding wires and the two arc power supplies. In a gas shielded triple-wire indirect arc welding method, before welding, one of three welding wires is first connected to positive electrodes of a first arc power supply and a second arc power supply, the other two welding wires are respectively connected to negative electrodes of the first arc power supply and the second arc power supply, and a welding workpiece is not connected to the arc power supplies. The welding wire connected to the positive electrodes of the two arc power supplies are arranged in the middle, and the other two welding wires are respectively arranged on both sides. The welding method is used for implementing build-up welding.

### TECHNICAL FIELD

The present disclosure belongs to the technical field of material processing, relating to an indirect arc welding method, in particular to a gas shielded triple-wire indirect electric-arc welding method, device and application thereof.

### BACKGROUND ART

At present, gas metal arc welding has been widely used in all walks of life, but it is still difficult to meet the needs of the rapid development of modern manufacturing industry.

In recent years, some efficient gas mental arc welding has been successively put forward, popularized and applied. In these methods, the key to improve welding efficiency is to improve deposition efficiency of the welding wire, that is, to increase welding current. Because the power supply, the workpiece and the welding wires form a circuit, the current flowing through the welding wires and the workpiece is bound to be equal. Therefore, increasing the welding current to increase the welding wire cladding rate is bound to increase the heat input of the workpiece, and too much heat input will lead to a series of problems such as the reduction of welding joint performance and the increase of welding deformation.

Therefore, the indirect arc welding method is proposed, which differs from traditional arc welding in that the workpiece does not contact the power supply and the arc only occurs between the electrodes. Indirect arc studied at present is mainly twin-wire indirect electric-arc^{[1-3]}; however, the existing twin-wire indirect arc welding has obvious limitation, as shown in FIG. 1, twin-wire indirect arc welding, especially the connection mode of the power supply and distribution mode of the welding wire, may have arc dispersion phenomenon under electromagnetic effect when the current of twin-wire indirect arc welding increases to a certain value, which cannot guarantee the stability of the welding process, and the deposition efficiency and welding efficiency are limited. Therefore, there are some shortcomings such as insufficient heat input to base material and narrow selection of welding parameters.

In view of the shortages of two-wire indirect arc, the invention application (APP. No. 201510145041.4) disclosed a gas shielded triple-wire indirect arc welding method, as shown in FIG. 2 and FIG. 3, which is the principle of triple-wire indirect arc welding and four kinds of the arrangement mode of welding wires (as shown in FIG. 3, FIG. 3 panel a is that three welding wires are distributed on one plane; FIG. 3 panel b is that the side wires are on each side of the middle welding wire; FIG. 3 panel c is that the side wires are simultaneously on one side of the middle welding wire; FIG. 3 panel d is that the middle welding wire is inclined at a certain angle from the horizontal line, etc.; wherein, z is the main wire, namely the middle welding wire, and b is the side wire.) By using different combination of the power supply and arrangement of the welding wire, the melting efficiency of welding wire is effectively improved and the adjustable range of indirect arc welding parameters are effectively expanded. But the technical solution still has some shortcomings, in the structure, the central symmetry of the two side wires with respect to the main wire makes the magnetic field between the main wire and the side wires central symmetric with respect to the main wire, which causes the two indirect arcs are independent of each other and offset at the tail, so as to increase the area of the arc acting on the base material, decreases the energy density of the electric-arc, and reduce the penetration force of the arc, resulting in the insufficient heat input to the workpiece. In addition, the distribution space of the three wires is larger, resulting in the welding torch volume too large, which is not conducive to the popularization and application of this technology.

Based on the defects of the indirect arc welding mentioned above and the causes thereof, it is necessary to provide a method and device of gas shielded triple-wire indirect arc welding to solve the problems.

### REFERENCES

1. Cao Meiqing, Zou Zengda, Wang Chunmao, et al. Influence of welding current on arc characteristics of twin-wire indirect arc welding [J]. Transactions of the China Welding Institution, 2005, 26(12): 47-50.
2. Cao Meiqing, Zou Zengda, Qu Shiyao. Relationship between metal transfer and arc shape in twin-wire indirect arc welding [J]. ransactions of the China Welding Institution, 2012, 33(6): 47-50.
3. Zhang Shunshan, Zou Yong, Zou Zengda. Effect of applied magnetic field on metal transfer of twin-wire indirect arc welding [J]. Transactions of the China Welding Institution, 2011, 32(6):69-72.

### SUMMARY OF THE INVENTION

According to the above mentioned technical problems that arc deflects to both sides in the existing gas shielded triple-wire indirect arc welding method, the present disclosure provides a gas shielded triple-wire indirect electric-arc welding method, the device and application thereof. The present disclosure mainly adopts mirror symmetric welding wire arrangement mode and a specific connection mode of the welding wire (that is, the main wire is connected to the positive electrodes and the side wires to the negative electrodes of the power supplies), optimizing the spatial distribution of magnetic field between indirect arcs and enhancing the magnetic field intensity between welding wires at the same time, so as to solve the problem of deflection at the tail of the two indirect arcs in the process of welding and increase the energy density and stiffness of the arcs, which realize the effective design and control of welding heat input of the workpiece and improve the application scope of the technology. The technical solutions of the present disclosure are as follows:

A gas shielded triple-wire indirect arc welding method, in which the welding process is implemented by means of three welding wires and two arc power supplies; the method includes the following steps:

Before welding, one of the three welding wires is connected to the positive electrodes of the two arc power supplies, the other two welding wires are connected to the negative electrodes of the two arc power supplies, and the welding workpiece does not connect to the electric-arc power supplies; then the welding wire connecting the positive electrodes of the two arc power supplies is arranged in the middle, which is named the main wire; the other two welding wires are respectively arranged on both sides of the main wire, which are named the side wire;

The two side wires respectively form an included angle of 20°-60° with the main wire; the two side wires respectively intersect with the extension line of the main wire and the two intersection points are on the same horizontal line; an orthographic projection of the side wires and the main wire in a plane perpendicular to the welding direction satisfies the following conditions: an included angle of the side wire and the main wire is 0°-5° and the two side wires are mirror symmetric with respect to the main wire;

During welding, the two electric-arc power supplies simultaneously output to produce coupled indirect arcs have a concentrated arc shape at the intersection points between the main wire and the side wires (the magnetic field distribution is optimized and the shape of the two indirect arcs becomes concentrated due to the use of the arrangement mode of the welding wire), the two indirect arcs simultaneously deflect to the main wire and couple to a single arc having increased current density and enhanced penetration ability; the coupled indirect arc is used to process the base metal; according to a preset welding process, the welding wire metal and part of the base metal are made to melt, followed by cooling and solidification to form welded joint, so as to realize a welding process with high deposition rate and larger depth of fusion.

Preferably, the total welding current (refers to the total welding current in the welding process, since the total welding current before and after coupling does not change, the total welding current after coupling is equal to the total welding current) ranges from 250 A to 600 A, the wire feed speed of the main wire ranges from 3.5 m/min to 15 m/min, and the welding speed ranges from 0.3 m/min to 2 m/min; and a welding torch composed of the three welding wires can be arranged vertically downward or at a certain inclined angle with the horizontal line, the inclined angle ranges from 20° to 120°.

Preferably, the two arc power supplies are selected one of the combinations of two DC power supplies, two pulsed power supplies, and one DC power supply and one pulsed power supply.

Preferably, a shielding gas used in the welding process of the welding method is one of CO₂, Ar, or a mixture of CO₂ and Ar, and the shield gas flow is 0.1-50 L/min.

The present disclosure also provides a device for realizing the gas shielded triple-wire indirect arc welding method, which is composed of three welding wires and two arc power supplies;

One of the three welding wires is connected to the positive electrodes of the two arc power supplies and is arranged in the middle of the three welding wires, which is named the main wire; the other two welding wires are connected to the negative electrodes of the two arc power supplies, and are respectively arranged on both sides of the main wire, which are named the side wire.

The two side wires respectively form an included angle of 20°-60° with the main wire, and the orthographic projection of the side wires and the main wire in a plane perpendicular to the welding direction satisfies the following conditions: the included angle of the side wire and the main wire is 0°-5° and the two side wires are mirror symmetric with respect to the main wire.

The welding workpiece does not connect to the electric-arc power supplies; the two side wires respectively intersect with the extension line of the main wire and the two intersection points are on the same horizontal line.

During welding, the two electric-arc power supplies simultaneously output to produce coupled indirect arcs having a concentrated arc shape at the intersection points between the main wire and the side wires, and the two indirect arcs simultaneously deflect to the main wire and couple to a single arc having increased current density and enhanced penetration ability; the coupled indirect arc is used to process the base metal; according to a preset welding process, the welding wire metal and part of the base metal are melted, followed by cooling and solidification to form welded joint, so as to realize a welding process with high deposition rate and larger depth of fusion.

Preferably, the integral welding torch composed of the three welding wires can be arranged vertically downward or at a certain inclined angle with the horizontal line, and the inclined angle ranges from 20° to 120°.

Preferably, the two arc power supplies are selected one of combinations of two DC power supplies, two pulsed power supplies, and one DC power supply and one pulsed power supply.

Preferably, a shielding gas used in the welding process of the welding method is one of CO₂, Ar, or a mixture of CO₂ and Ar, and the shield gas flow is 0.1-50 L/min.

The present disclosure also provides a build-up welding method based on the gas shielded triple-wire indirect arc, including adopting the gas shielded triple-wire indirect arc welding method mentioned above, and in the process of build-up welding, a direction parallel to a vertical plane of the welding wires and a direction perpendicular to the vertical plane of the welding wire are respectively taken as a build-up welding, the three welding wires are used as filler metal, and the arc column heat of the coupled indirect arc and the heat carried by metal transfer are utilized to realize the welding between the filler metal and the welding workpiece.

The present disclosure also provides an efficient method based on the gas shielded triple-wire indirect arc, including adopting the gas shielded triple-wire indirect arc welding method mentioned above, and in the process of welding, a direction parallel to a vertical plane of the welding wires is taken as the welding direction and mirror symmetric welding wire arrangement is used to obtain a single-pass welding depth of fusion greater than or equal to 10 mm under a condition of groove angle less than 20°.

Compared with the existing art, the present disclosure has some advantages as follows:

1. The workpiece in the gas shielded triple-wire indirect arc welding provided in the present disclosure does not connect to the power supply, and the arc only forms indirect arc at the end of the welding wires. The heat input of the workpiece is increased, the deposition coefficient of the welding wires is high, and the energy is saved.

2. By using the mirror symmetric welding wire arrangement, the present disclosure realizes the optimization of the spatial distribution of magnetic field between the indirect arcs, and enhances the magnetic field intensity between the welding wires, which solves the problem that the tail part of the two indirect arcs deflect to both sides during welding while the shape of the two indirect arcs are concentrated.

3. The present disclosure makes two indirect arcs directly coupled into a single arc by using a specific welding wire connection mode (that is, the main wire is connected to the positive electrodes and the side wires to the negative electrodes of the power supplies), which improves the energy density and stiffness of the arc and increases the penetration ability of the arc.

In addition, the method of the present disclosure can effectively compress the distribution space of three welding wires and reduce the volume of the composite welding torch, which is conducive to the popularization and application of the technology

### BRIEF DESCRIPTION OF THE DRAWINGS

In order to more clearly illustrate the embodiments of the present disclosure or the technical solutions in the prior art clearer, the drawings required in the description of the embodiments or the prior art will be briefly introduced below. Obviously, the drawings in the following descriptions are some embodiments of the present disclosure. For those of ordinary skilled in the art, other drawings can be obtained based on these drawings without inventive effort.

FIG. 1 is a schematic diagram of twin-wire indirect arc welding in the prior art;

FIG. 2 is a schematic diagram of triple-wire indirect arc welding in the prior art;

FIG. 3 is a schematic diagram of the arrangement mode of triple-wire indirect arc welding wire in the prior art;

FIG. 4 is a schematic diagram of triple-wire indirect arc welding of the present disclosure;

FIG. 5 is a schematic diagram of the arrangement mode of triple-wire indirect arc welding wire of the present disclosure; FIG. 5 panel I is a schematic diagram that the line of sight is perpendicular to the welding direction, and FIG. 5 panel II is a schematic diagram that the line of sight is parallel to the welding direction;

FIG. 6 is a comparison diagram of the build-up welding effect of the present disclosure and the triple-wire indirect arc build-up welding effect in the prior art;

FIG. 7 is a schematic diagram of one embodiment of the gas shielded triple-wire indirect arc welding in the present disclosure;

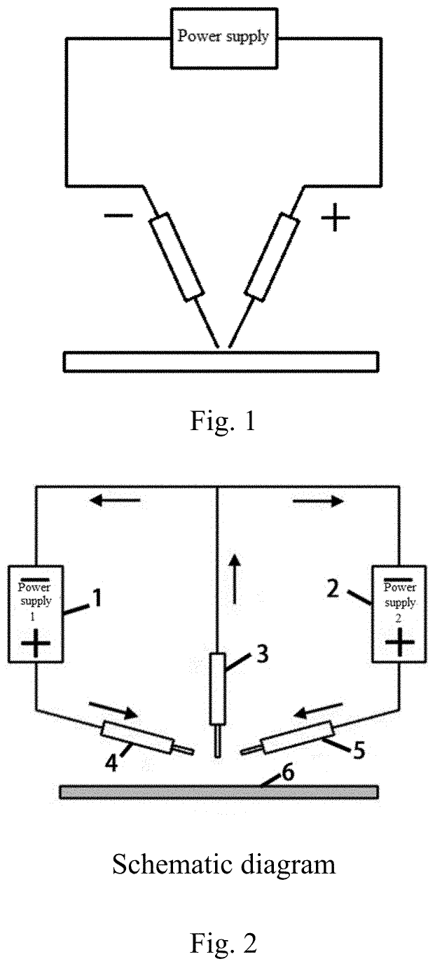

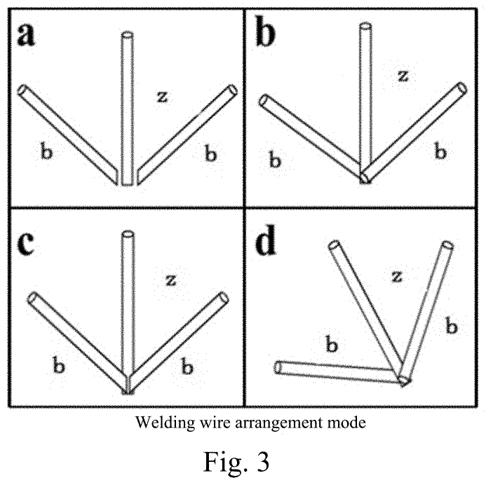

wherein, 1—the first arc power supply, 2—the second arc power supply, 3—the main wire, 4—the first side wire, 5—the second side wire, 6—base metal to-be-welded, 7—ceramics backing.

### DETAILED DESCRIPTION OF THE PREFERRED EMBODIMENTS

It should be noted that, the embodiments and the characteristics in the embodiments of the present disclosure can be combined with each other without conflict. The present disclosure will be illustrated in detail by referring to the accompany drawings combining with the embodiments.

To make the objective, technical solutions and advantages of the present disclosure clearer, a clear and complete description of the embodiments in the present disclosure may be given herein after in combination with the accompany drawings of the embodiment. Obviously, the embodiments described below are part embodiments of the present disclosure, not all of them. The following description of at least one embodiment is in fact only illustrative and is in no way as a limitation on the present disclosure and its application or use. Based on the embodiments in the present disclosure, all other embodiments obtained by those skilled in the art without inventive effort are within the protection scope of the present disclosure.

It should be noted that the terms used herein are only intended to describe the embodiments and are not intended to limit the exemplary implementations of the present disclosure. As used herein, unless indicated obviously in the context, a singular form is also intended to include the plural form. Furthermore, it should be understood that when the terms “comprise” and/or “include” used in this specification indicate the presence of features, steps, operations, devices, components and/or combinations thereof.

Unless otherwise specified, the relative arrangement of components and steps, numerical expressions, and numerical values set forth in these embodiments do not limit the scope of the present disclosure. In addition, it should be clear that, for the ease of description, the sizes of the parts shown in the accompany drawings are not drawn in accordance with actual proportions. The technologies, methods and devices known to those skilled in the relevant arts may not be discussed in detail, but where appropriate, the technologies, methods and devices should be considered as part of the authorized specification. In all the embodiments shown and discussed herein, any specific value should be interpreted as merely being exemplary rather limiting. Therefore, other embodiments of the exemplary implementations may have different values. It should be noted that similar labels and letters represent similar items in the accompany drawings below indicate similar items. Therefore, once an item is defined in one accompany drawing, there is no need to discuss it further in subsequent accompany drawings.

In the description of the present disclosure, it should be understand that the orientations or position relationships indicated by the orientation terms such as “front, rear, up, down, left, and right”, “transversal, vertical, perpendicular, and horizontal”, and “top and bottom” are usually based on the orientation or position relationship shown in the drawings, which are only for the convenience of describing the present disclosure and simplifying the description. In the absence of a contrary explain, these orientation terms do not indicate or imply that the device or element referred to must have a specific orientation or be constructed and operated in a specific orientation, therefore cannot be understood as a limitation on the protection scope of the present disclosure: the orientation words “inner and outer” refer to the inside and outside relative to the contour of each component.

For ease of description, spatial relative terms, such as “on”, “over”, “on the upper surface”, “over”, etc., can be used herein to describe a spatial position relationship between one device or feature and other devices or features as shown in the drawings. It should be understood that the spatial relative terms are intended to include different orientations in use or operation in addition to the orientation of the device described in the drawings. For example, if the device of the drawing is inverted, a device described as “above other device or structure” or “on other device or structure” will then be positioned as “below other device or structure” or “beneath a device or structure”. Thus, the exemplary term “above” can include both orientations of “above” and “below”. The device can also be positioned in other different ways (rotating 90 degrees or in other orientations), and the spatially relative description used herein is explained accordingly.

In addition, it should be noted that the terms such as “first” and “second” used to define parts is only for the convenience of distinguishing the corresponding parts. Unless otherwise stated, the foregoing words have no special meaning and therefore cannot be interpreted as a limitation on the protection scope of the present disclosure.

The present disclosure provides a gas shielded triple-wire indirect arc welding method, a device and an application thereof. By using the mirror symmetric welding wire arrangement and the welding wire connection mode of the main wire connected to the positive electrode of the supply and the side wire to the negative electrode of the power supply, the magnetic field intensity of the indirect arc is improved, the problem of deflection at the tail of the two indirect arcs in the gas shielded triple-wire indirect arc welding method is effectively solved, at the same time, under the condition of keeping the welding current constant, the arc pressure of the indirect arc is increased by adjusting the wire feed speed of the main wire, so that the energy density and welding heat input of the indirect arc are greatly increased, the arc penetration ability is enhanced, and the stability of the indirect arc is effectively improved. In addition, the distribution space of the three welding wires is greatly reduced, and the welding gun head is greatly reduced, which improves the practical performance of the technology.

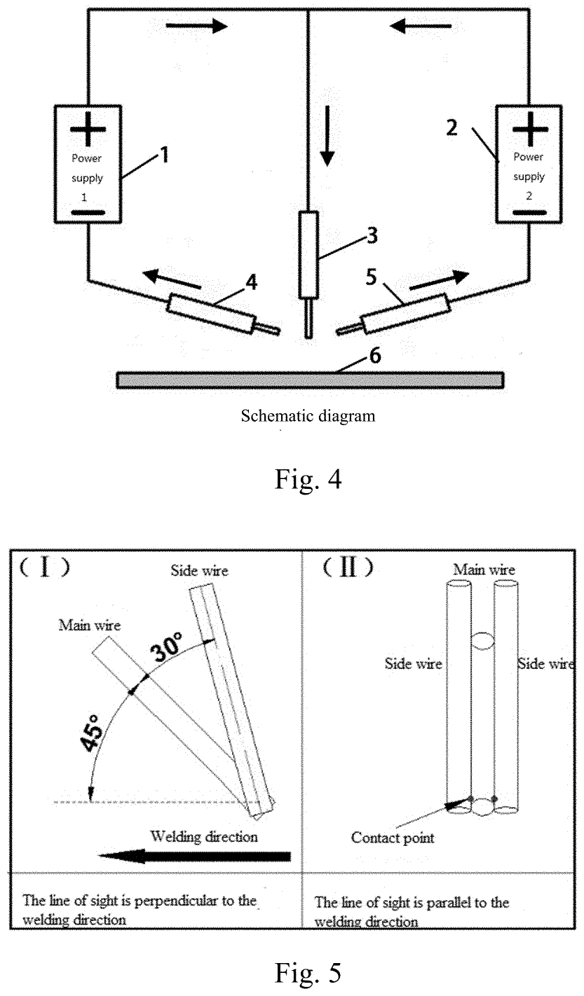

As shown in FIG. 4, the welding process is implemented by three welding wires and two arc power supplies, in particular including:

Before welding, firstly, one of the three welding wires is connected to the positive electrodes of the two arc power supplies (i.e., the positive electrodes of the first arc supply 1 and the second arc power supply 2), the other two welding wires are respectively connected to the negative electrodes of the first arc power supply 1 and the second arc power supply 2, and the welding workpiece does not connect to the arc power supplies; the two arc power supplies are one of the combinations of two DC power supplies, two pulsed power supplies, and one DC power supply and one pulsed power supply.

Then, the welding wire connected to the two positive electrodes of the arc power supplies is arranged in the middle, which is named the main wire 3; the other two welding wires are respectively arranged on both sides of the main wire, which are named the first side wire 4 and the second side wire 5.

In space, the included angle formed by the first side wire 4 and the main wire 3, and that formed by the second wire 5 and the main wire 3 range from 20° to 60°; the two side wires respectively intersect with the extension line of the main wire 3 and the two intersection points are on the same horizontal line. As shown in FIG. 5, the orthographic projection of the side wires and the main wire 3 in a plane perpendicular to the welding direction satisfies the following conditions: the included angle between the first side wire 4 and the main wire 3 and that between the second side wire 5 and the main wire 3 are 0°-5°, and the two side wires are mirror symmetric with respect to the main wire 3.

During welding, the two arc power supplies simultaneously output to produce indirect arcs at the intersection points between the main wire 3 and the side wires; the two indirect arcs simultaneously deflect to the main wire 3 and are coupled to a single arc having increased current density and enhanced penetration ability; the coupled indirect arc is used to process the base metal 6, under the condition of keeping the welding current constant, according to a preset welding process, a wire feed speed of the main wire 3 is adjusted to control the arc energy to melt the welding wire metal and part of the base metal to-be-welded 6, followed by cooling and solidification to form welded joint, so as to realize a welding process with high deposition rate and large depth of fusion.

The total welding current ranges from 250 A to 600 A, the wire feed speed of the main wire 3 ranges from 3.5 m/min to 15 m/min, and the welding speed ranges from 0.3 m/min to 2 m/min. The welding torch composed of the three welding wires can be arranged vertically downward or at a certain inclined angle with the horizontal line, and the inclined angle ranges from 20° to 120°. The shield gas used in the welding process of the welding method can be one of CO₂, Ar, or a mixture of CO₂ and Ar, and the shield gas flow is 0.1-50 L/min.

The present disclosure provides a device for realizing the above gas shielded triple-wire indirect arc welding method and the device is composed of three welding wires and two arc power supplies. One of the three welding wires is connected to the positive electrodes of the two arc power supplies, and is arranged in the middle of the three welding wires, which is named the main wire 3; the other two welding wires are connected to the negative electrodes of the two arc power supplies, and are respectively arranged on both sides of the main wire, which are named the side wires.

The two side wires respectively form an included angle of 20°-60° with the main wire 3, and the orthographic projection of the side wires and main wire 3 in a plane perpendicular to the welding direction satisfies the following conditions: the included angle of the side wires and the main wire 3 is 0°-5° and the two side wires are mirror symmetric with respect to the main wire 3.

The welding workpiece does not connect to the arc power supplies, and the two side wires respectively intersect with the extension line of the main wire 3 and the two intersection points are on the same horizontal line.

During welding, the two arc power supplies simultaneously output to produce indirect arcs at the intersection points between the main wire 3 and the side wires, the two indirect arcs simultaneously deflect towards the main wire and couple to a single arc having increased current density and enhanced penetration capability; the coupled indirect arc is used to process the base metal 6, under the condition of keeping the welding current unchanged and according to a preset welding process, the wire feed speed of the main wire 3 is adjusted to control the arc energy to make the base metal to-be-welded 6 melted at the direction of thickness, followed by cooling and solidification to form the welded joint, so as to realize a welding process with high deposition rate and large depth of fusion.

The present disclosure also provides a build-up welding method based on the gas shielded triple-wire indirect arc, including adopting the above mentioned gas shielded triple-wire indirect arc welding method, and in the process of build-up welding, a direction parallel to a vertical plane of the welding wires and a direction perpendicular to the vertical plane of the welding wires are respectively taken as the build-up welding direction, the three welding wires are used as filler metal, and arc column heat of the coupled indirect electric-arc and the heat carried by metal transfer are utilized to realize the welding of the filler metal and the welding workpiece.

As shown in FIG. 7, the present disclosure also provides a high effective welding process based on the gas shielded triple-wire indirect arc, including adopting the above mentioned gas shielded triple-wire indirect arc welding method, and in the process of welding, a direction parallel to a vertical plane of the welding wires is taken as a welding direction and the mirror symmetric welding wire arrangement is used to obtain a single-pass welding depth of fusion greater than or equal to 10 mm under a condition of groove angle less than 20°. It can be seen that the groove angle adopted by the present invention is smaller, which can be reduced to less than 10°, meeting the requirements of high speed and single-pass welding of the thin plate and the medium thickness plate.

The specific working principle of the present disclosure is:

The present disclosure realizes the arc shape concentration and arc energy control of the indirect arc welding by adopting the mirror symmetric welding wire arrangement mode and the specific welding wire connection mode as well as the control of the wire feed speed of the main wire 3. By using the mirror symmetric welding wire arrangement mode and the specific welding wire connection mode (the main wire is connected to the positive electrodes and the side wires to the negative electrodes of the power supplies), the spatial distribution of the magnetic field between the arcs is optimized, and the magnetic field intensity is improved; and, the indirect arcs respectively formed between the main wire 3 and the two side wires deflect to the main wire 3 at the same time, and the two indirect arcs directly couple to a single arc having higher current density. Therefore, the shape of the obtained indirect arc is concentrated, and the energy density, stiffness and penetration ability of the electric-arc are increased. In addition, under the condition of keeping the welding current constant, the arc pressure of the indirect arc is controlled by adjusting the wire feed speed of the main wire 3, so as to control the indirect arc energy. The present disclosure uses the coupled single arc to improve the indirect arc penetration ability while make the arc energy controllable, meeting the high efficient welding requirements of plate build-up welding and single-pass forming of thin plate and medium thick plate.

### Embodiment 1: Gas Shielded Triple-Wire Indirect Arc Parallel Build-Up Welding

The welding wire arrangement mode showed in FIG. 5 is adopted, the included angle between the main wire 3 and the horizontal direction is 45°, and the included angles between the first side wire 4 and the main wire 3 and that between the second side wire 5 and the main wire 3 are 30° respectively; the two side wires are distributed on both sides of the main wire 3 and mirror symmetric with respect to the main wire 3, the two side wires respectively contacts with the main wire 3, and the two contact points are on the same horizontal line. Wherein, the model of the three steel welding wires is ER 50-6, the diameter of the main wire 3 is 1.6 mm, and the diameter of the two side wires is 1.2 mm; the power supplies use a DC power supply as the first arc power supply 1 and a pulsed DC power supply as the second arc power supply 2; the shield gas is a mixture of 80% CO₂ and 20% Ar. Plane build-up welding is implemented on Q235 steel plate as the base material, the direction of build-up welding is parallel to the vertical plane where the welding wires are located (parallel build-up welding); the size of the plate is 200 mm×100 mm×6 mm, and the height of the welding gun is 5 mm; the total welding current is 320 A, and the welding speed is 600 mm/min. Finally, the welded joint was obtained, which was smooth, uniform, consistent and well combined with the base material, and had no defects.

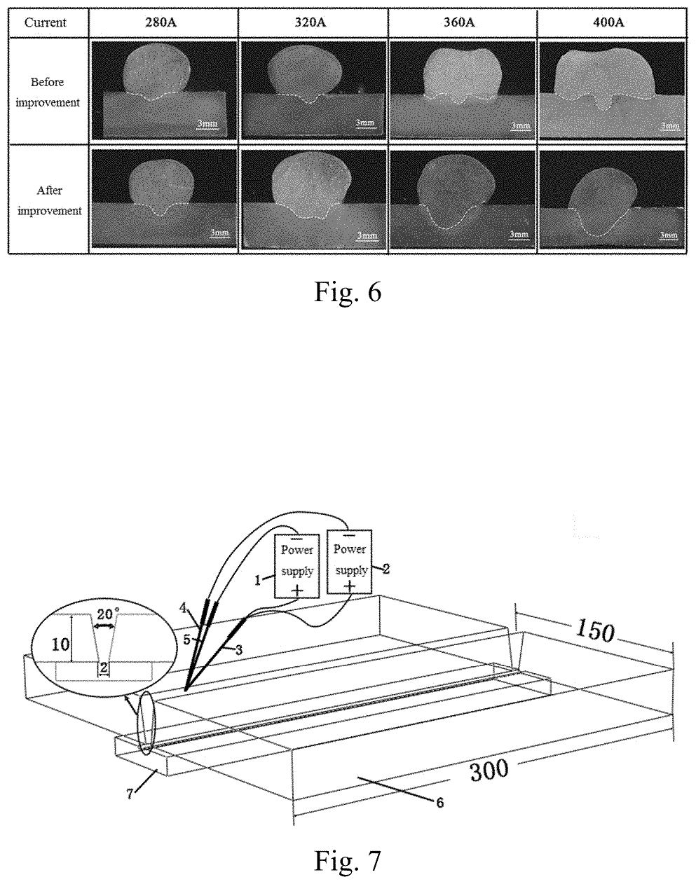

FIG. 6 shows the comparison of build-up welding morphology at different welding current before and after the improvement of triple-wire indirect arc welding. It can be seen from the figure that by using the above welding wire arrangement mode and specific welding wire connection mode (the main wire is connected to the positive electrodes and the side wires to the negative electrodes of the power supplies), the fusion depth and fusion amount of the base metal are greatly improved, which demonstrate that the gas shielded triple-wire indirect arc build-up welding has the advantages of high deposition rate and larger depth of fusion.

### Embodiment 2: Gas Shielded Triple-Wire Indirect Arc Vertical Build-Up Welding

The welding wire arrangement mode showed in FIG. 5 is adopted, the included angle between the main wire 3 and the horizontal direction is 45°, and the included angles between the first side wire 4 and the main wire 3 and that between the second side wire 5 and the main wire 3 are 30° respectively; the two side wires are distributed on both sides of the main wire 3 and mirror symmetric with respect to the main wire 3, the two side wires respectively contacts with the main wire 3, and the two contact points are on the same horizontal line. Wherein, the model of the three steel welding wires is ER 50-6, the diameter of the main wire 3 is 1.6 mm, and the diameter of the two side wires is 1.2 mm; the power supplies use a DC power supply and a pulsed DC power supply; the shield gas is a mixture of 80% CO₂ and 20% Ar. Plane build-up welding is implemented on Q235 steel plate as the base metal, the direction of build-up welding is perpendicular to the vertical plane where the welding wires are located (vertical build-up welding); the size of the plate is 200 mm×100 mm×6 mm, the height of the welding gun is 5 mm, the total welding current is 360 A, and the welding speed is 650 mm/min. Finally, the welded joint was obtained, which was smooth, uniform, consistent and well combined with the base metal, and had no defects, thus demonstrating that the gas shielded triple-wire indirect arc build-up welding has the advantages of high deposition rate and high efficiency of build-up welding.

### Embodiment 3: Single-Pass Forming Gas Shielded Triple-Wire Indirect Arc Welding

As shown in FIG. 7, the welding wire arrangement mode showed in FIG. 5 is adopted, the included angles between the main wire 3 and the side wires are 30°, the diameter of the main wire adopted is 1.6 mm, and the diameter of the two side wires is 1.2 mm, the model of the welding wires is ER 50-6, the welding base metal is Q235 low-carbon steel with the size of 300 mm×150 mm×10 mm and the groove angle of 20° without blunt edge, a ceramic backing 7 is used on the back, the butt gap is 2 mm, the total welding current is 320 A, the welding speed is 735 mm/min. The welding joint with good single-pass forming was obtained. Due to the smaller groove angle, the welding wire deposition rate is higher and the welding speed is faster, which has the characteristics of high efficiency.

Finally, it should be noted that the above embodiments are only used to illustrate the technical solutions of the present disclosure without limiting; although the present disclosure is described in detail with reference to some embodiments, the ordinary skilled in the art should understand that they may still make amendments to the technical solutions disclosed in the embodiments, or make equal replacements for some or all of their technical characteristics; these amendments or replacements do not remove the essence of the corresponding technical solutions from the scope of the technical solutions of the present disclosure.

1. A gas shielded triple-wire indirect arc welding method, in which the welding process is implemented by means of three welding wires and two arc power supplies; wherein the method comprising:
before welding, connecting one of the three welding wires to the positive electrodes of the two arc power supplies, respectively connecting the other two welding wires to the negative electrodes of the two arc power supplies, and a welding workpiece being not connected to the arc power supplies; then arranging the welding wire connecting the positive electrodes of the two arc power supplies in the middle, which is named the main wire; respectively arranging the other two welding wires on both sides of the main wire, which are named the side wire;
wherein, the two side wires respectively form an included angle of 20°-60° with the main wire; and the two side wires respectively intersect with an extension line of the main wire and the two intersection points are on the same horizontal line; an orthographic projection of the side wires and the main wire in a plane perpendicular to the welding direction satisfies the following conditions: an included angle between the side wire and the main wire is 0°-5° and the two side wires are mirror symmetric with respect to the main wire;
during welding, making the two arc power supplies simultaneously output to produce coupled indirect arcs having a concentrated arc shape at the intersection points between the main wire and the side wires, and the two indirect arcs simultaneously deflecting to the main wire and coupling to a single arc having increased current density and enhanced penetration ability; using the coupled indirect arc to process a base metal; according to a preset welding process, making the welding wire metal and part of the base metal melted, followed by cooling and solidification to form welded joint, so as to realize a welding process with high deposition rate and larger depth of fusion.

2. The gas shielded triple-wire indirect arc welding method according to claim 1, wherein a total welding current ranges from 250 A to 600 A, a wire feed speed of the main wire ranges from 3.5 m/min to 15 m/min, and a welding speed ranges from 0.3 m/min to 2 m/min; and a welding torch composed of the three welding wires is arranged vertically downward or at a certain inclined angle with the horizontal line, the inclined angle ranges from 20° to 120°.

3. The gas shielded triple-wire indirect arc welding method according to claim 1, wherein the two arc power supplies are selected from the group consisting of two DC power supplies, two pulsed power supplies, and a combination of one DC power supply and one pulsed power supply.

4. The gas shielded triple-wire indirect arc welding method according to claim 1, wherein a shielding gas used in the welding process is one of CO₂, Ar, or a mixture of CO₂ and Ar, and a shield gas flow is 0.1-50 L/min.

5. A device for realizing the gas shielded triple-wire indirect arc welding method according to claim 1, which is composed of three welding wires and two arc power supplies;
wherein, one of the three welding wires is connected to the positive electrodes of the two arc power supplies, and is arranged in the middle of the three welding wires, which is named the main wire;
the other two welding wires are connected to the negative electrodes of the two arc power supplies, and are respectively arranged on both sides of the main wire, which are named the side wire;
the two side wires respectively form an included angle of 20°-60° with the main wire, and the orthographic projection of the side wires and main wire in a plane perpendicular to the welding direction satisfies the following conditions: the included angle of the side wire and the main wire is 0°-5° and the two side wires are mirror symmetric with respect to the main wire;
the welding workpiece is not connected to the arc power supplies; the two side wires respectively intersect with the extension line of the main wire and the two intersection points are on the same horizontal line;
during welding, making the two arc power supplies simultaneously output to produce coupled indirect arcs having a concentrated arc shape at the intersection points between the main wire and the side wires, and the two indirect arcs simultaneously deflecting to the main wire and coupling to a single arc having increased current density and enhanced penetration ability; using the coupled indirect arc to process the base metal, according to the preset welding process, making the welding wire metal and part of the base metal melted, followed by cooling and solidification to form welded joint, so as to realize a welding process with high deposition rate and larger depth of fusion.

6. The device according to claim 5, wherein the integral welding torch composed of the three welding wires is arranged vertically downward or at a certain inclined angle with the horizontal line, and the inclined angle ranges from 20° to 120°.

7. The device according to claim 5, wherein the two arc power supplies are selected from the group consisting of two DC power supplies, two pulsed power supplies, a combination of one DC power supply and one pulsed power supply.

8. The device according to claim 5, wherein a shielding gas used in the welding process is one of CO₂, Ar, or a mixture of CO₂ and Ar, and a shield gas flow is 0.1-50 L/min.

9. A build-up welding method based on the gas shielded triple-wire indirect arc, comprising the methods according to claim 1; in a process of build-up welding, respectively taking a direction parallel to a vertical plane of the welding wires and a direction perpendicular to the vertical plane of the welding wires as build-up welding direction, using the three welding wires as filler metal, and utilizing an arc column heat of the coupled indirect arc and a heat carried by metal transfer, to realize the welding between the filler metal and the welding workpiece.

10. An efficient welding method based on the gas shielded triple-wire indirect arc, comprising the methods according to claim 1; and in a process of welding, taking a direction parallel to a vertical plane of the welding wires as welding direction and using mirror symmetric welding wire arrangement, to obtain a single-pass welding depth of fusion greater than or equal to 10 mm under a condition of groove angle less than 20°.
